(19) United States
(12) Patent Application Publication
(10) Pub. No.: US 2012/0021134 A1
(43) Pub. Date: Jan. 26, 2012

(54) PROCESS AND APPARATUS FOR COATING WITH REDUCED DEFECTS

(75) Inventors: William Blake Kolb, West Lakeland, MN (US); Peter E. Price, S. Minneapolis, MN (US); William R. Dudley, Geneseo, NY (US)

(73) Assignee: 3M INNOVATIVE PROPERTIES COMPANY, Saint Paul, MN (US)

(21) Appl. No.: 13/258,029

(22) PCT Filed: Mar. 16, 2010
(86) PCT No.: PCT/US2010/027433

§ 371 Date: Sep. 21, 2011

Related U.S. Application Data
(60) Provisional application No. 61/169,427, filed on Apr. 15, 2009.

(51) Int. Cl. C08F 2/48; B05C 9/12; B05D 3/00

(52) U.S. Cl. 427/508; 118/67; 427/372.2; 118/620

(57) ABSTRACT

A process and apparatus for producing a polymer coating with reduced defects is described. The process includes coating a solution of a polymerizable material and a solvent on a substrate, polymerizing a portion of the polymerizable material, and removing a major portion of the solvent after polymerization of the portion of polymerizable material. A further polymerization of any remaining polymerizable material can occur after removal of the solvent. The apparatus includes a webline for conveying a substrate from an unwind roll to a windup roll, a coating section proximate the unwind roll for coating a solution of a polymerizable material and a solvent on the substrate, a polymerization section downweb from the coating section for polymerizing a portion of the polymerizable material, and a solvent removal section downweb from the polymerization section for removing the solvent after polymerization of the portion of the polymerizable material.

### BACKGROUND

Thin polymer coatings find use in many applications, particularly in thin film optical coatings, where coating uniformity can be critical to the optical performance. Precision coating of thin polymeric films often involves the use of a coating die that performs optimally with dilute, low viscosity coatings applied at a greater thickness than the desired coating. As a result, precision coatings are often applied from dilute, low percent solids solutions, and the dilution solvent is subsequently removed to result in the thin coating. Defects in the coating uniformity can occur during this solvent removal step.

The coating uniformity can be degraded by several processes, and can generally include a variation in film thickness and uniformity, both locally and globally. Mottle is one of the more common defects observed in thin polymeric coatings, such as optical coatings cast from solvent-based polymerizable solutions. Other common defects in thin polymeric coatings include dewets, streaks, and where particles are present in the solution, particle agglomeration.

Current thin film solution coating typically involves coating the web, conveying it through a span of open web into a drying oven, drying the solvents in a convective or gap drier, and polymerizing the coating under, for example, a high intensity ultraviolet (UV) lamp. In such systems, the coating is a thin, low viscosity coating for considerable time prior to solidification by polymerization. This increases the likelihood of mottling, or other disruptions to the coating that can form defects. Often, efforts to control mottle typically focus on contaminant control and formulation.

A technique is desired for reduction or elimination of these defects, since this would significantly increase the productivity and robustness of coated film manufacturing operations.

### SUMMARY

In one aspect, the present disclosure provides a process for producing a polymer coating. The process includes coating a first solution that includes a polymerizable material in a solvent on the substrate. The process further includes polymerizing a first portion of the polymerizable material, forming a homogenous composition that includes a partially polymerized material in a second solution, wherein the second solution is partially depleted of polymerizable material. The process further includes removing a major portion of the solvent from the homogeneous composition.

In another aspect, the present disclosure provides an apparatus for producing a polymer coating. The apparatus includes a webline for conveying a substrate downweb from an unwind roll to a windup roll. The apparatus further includes a coating section disposed proximate the unwind roll and capable of coating a first solution that includes a polymerizable material in a solvent onto the substrate. The apparatus further includes a polymerization section disposed downweb from the coating section and capable of polymerizing a first portion of the polymerizable material, forming a homogenous composition that includes a partially polymerized material in a second solution, wherein the second solution is partially depleted of polymerizable material. The apparatus further includes a solvent removal section disposed downweb from the polymerization section, capable of removing a major portion of the solvent from the homogeneous composition.

### BRIEF DESCRIPTION OF THE DRAWINGS

Throughout the specification reference is made to the appended drawings, where like reference numerals designate like elements, and wherein:

FIG. 1 is a schematic view of a process for forming a polymeric coating;

FIG. 2 is a schematic view of a process for forming a polymeric coating;

FIG. 3A is a schematic view of a process for forming a polymeric coating;

FIG. 3B is a schematic view of a polymerization section of FIG. 3A;

FIG. 3C is a schematic view of the polymerization section of FIG. 3B;

FIGS. 4A-4C are photographs of a bead-coating on a substrate; and

FIGS. 5A-5B are shadow photographs of a coating on a substrate.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

A process and apparatus is described that enables rapid web-based processing of radiation curable coatings with a reduction in coating defects. The coating uniformity can be affected by disturbances that can cause defects in the coating. These disturbances include, for example, the effect of air currents, particulate and chemical contaminants, equipment vibrations, thermal currents, and the like. The present process includes partially polymerizing a polymer in a solution before removing a major portion of the solvent from the solution. As the partial polymerization of the solution progresses, the viscosity of the composition increases and the coated solution becomes more resistant to disturbances that can affect the coating. Conventional techniques can be used to remove the major portion of the solvent after partial polymerization of the solution, and polymerization of the remainder of the coating can occur after removal of the solvent.

In one particular embodiment, the process may also include a controlled environment region between the coating station and the partial polymerization apparatus. This controlled environment can also influence the stability of the coated film by controlling, for example, the temperature of the environment surrounding the coating, evaporation of the solvent, gas/vapor composition surrounding the coating, and the like. In one particular embodiment, the controlled environment can include a polymeric film disposed over the coating, between the coating station and the partial polymerization apparatus.

The partial polymerization apparatus can be located anywhere after the coating has been applied, for example between the coating station and the solvent removal section. Control of the environment during the partial polymerization can also be desired, and can be accomplished as described elsewhere. The partially polymerized coating is subsequently dried by removal of solvent and can be further polymerized using, for example, conventional ultraviolet (UV) radiation systems to further cure the material.

UV curing soon after coating can pose problems when using traditional high intensity UV sources, because they tend to operate at higher temperatures. These higher temperatures can dry thin coatings within the controlled environment, leading to coating defects such as mottling. In one particular embodiment, UV LEDs can offer advantages for curing in a controlled environment region immediately after coating. UV LEDs can initiate polymerization without imparting additional thermal energy, and can therefore minimize drying by solvent evaporation.

In one particular aspect, the process can be used to reduce or eliminate common coating defects including, for example, mottling, dewets, particle agglomeration, and the like. In another aspect, the process can be used to control the surface roughness of the final coating to influence, for example, slip, anti wet-out, and the appearance of defects. The process can be particularly well suited to actinic radiation curable coatings on webs. For the purposes of the present disclosure, mottling defects are described as the defect; however, the technique can be applied to resolve other coating defects, in a similar manner.

The coatings may be cast from either neat (i.e., 100% solids) or solvent-based solutions of lower molecular weight monomers, oligomers, and pre-polymers. Often, thin film coating can be more readily accomplished by using a low viscosity coating solution that may have a low solids content (i.e., a high solvent content). The controlled environment region immediately following the fluid coating head can be used to condition the coating in preparation for partial polymerization, for example by removing a minor portion of the solvent, if desired. The controlled environment can further include UV LED's or other UV sources (lasers, lamps, etc.) to initiate polymerization soon after coating. By rapidly inducing polymerization, the viscosity of the coated solution rises, reducing its propensity to mottle the coating and/or flow on the macro-scale, as in mottling. In one particular embodiment, increased viscosity can also inhibit the movement of any particulates within the coating solution, and reduce agglomeration or undue spreading of the particulates in the final cured coating.

Dewetting generally means that a fluid film of a coating solution on a surface (such as a polymeric web) breaks up into regions that are essentially free of the coating solution, and other regions that are covered with the coating solution. The initial stages of dewetting often take the form of small circular regions of uncoated surface within the fluid film. In more extreme cases, the coating solution can end up as small droplets on a largely uncoated surface.

Although not wishing to be bound by theory, both dewetting and mottling can be generally initiated by a number of mechanisms including particulate contaminants, surface irregularities, and chemical impurities. Dewetting can generally be the result of intermolecular forces in the coating and substrate materials that drive the formation of a discontinuous or a nonuniform liquid film. The forces responsible for dewetting often result from contaminant particles in the coating or on the substrate, but can be inherent to the coating materials themselves, including for example surface tension and affinity for the substrate surface. Mottling often becomes more likely as coating thickness increases and viscosity decreases, and can be an important defect that reduces performance and productivity in thin (e.g., on the order of 0.1 micron to about 10 micron) optical coatings.

Many optical films contain coatings formed by coating photocurable solutions onto a moving substrate (i.e. web) in a continuous fashion. Often, a sufficiently thin coating can only be obtained by coating from solvent solutions having a low solids content. Solutions having a low solids content permit the initially coated liquid layer to be thicker, and therefore easier to control during coating. At the initially coated thickness, these thicker coatings are often stable liquid films, but can become susceptible to mottling defects. As the solvent evaporates from the coating, the coating becomes thinner and can become unstable to mottling and dewetting forces, either because of environmental contaminants or due to the nature of the materials themselves. Because these coatings generally include low molecular weight materials (e.g., monomers having a molecular weight of about 500 g/mole or less), and hence lower viscosity, mottling flows can occur prior to actinic radiation induced polymerization.

Initiating the polymerization process soon after coating causes the molecular weight of the polymerizable material, and corresponding viscosity of the coating, to increase dramatically. This viscosity increase results in more stable coatings as the solvent evaporates, reducing or eliminating mottles and other disruptions to the coating. In one particular embodiment, because many of these thin coatings dry on a time scale of seconds, the region immediately following the coating head can be an advantageous location for the polymerization apparatus.

In one particular embodiment, the partial polymerization apparatus uses recently developed ultraviolet light emitting diode (UV LED) systems. An advantage of UV LED systems include the compact size of the units, which can readily be positioned close to the coating station. Another advantage of UV LED systems is that they can also radiate very little infrared radiation, which results in reduced heating of the coating and decreased solvent evaporation. These characteristics can enhance the safe operation of the polymerization apparatus, and make it practical to expose UV-curable compositions in an environment where a coating solvent is present. UV LED systems can be configured to operate at several desired peak wavelengths, such as 365 nm, 385 nm, 395 nm, 405 nm, and the like. Other radiation sources may be used, such as, for example, UV lasers, UV lamps, germicidal UV bulbs, visible lamps, flashlamps, and the like; and other high-energy particle devices, including, for example, electron-beam (EB) sources and the like. In one particular embodiment, UV LED systems can provide advantages over the other radiation sources.

The polymerization can occur rapidly, and the partial polymerization apparatus can be placed between a coating station and a conventional solvent removal system. The partial polymerization apparatus can also be placed within conventional drying equipment or between a series of conventional drying equipment, as long as there is still a portion of the solvent present within the coated film at the onset of cure. In some embodiments, the partial polymerization can instead occur in a 100% solids formulation, for example when low molecular weight monomers that are susceptible to evaporation after coating are present in the formulation. These low molecular weight monomers that are susceptible to evaporation can be described as reactive solvents.

Several processing parameters can affect the resulting polymeric coating, including, for example, web speed, coating thickness, UV LED peak wavelength, intensity, dose, temperature, and composition of the coating at the onset of polymerization.

Other processing parameters that can affect the resulting polymeric coating include composition of the coating during polymerization, and environmental control, including, for example, gas phase composition, gas flow fields, and gas flow rates. Gas phase composition can include both solvent composition and concentration, and oxygen concentration particularly near the polymerization region. Control of the coated film environment from coating application through the polymerization process is desired, and can be accomplished with temperature-controlled enclosures with both supply and removal of conditioned gas. In some cases, simultaneous curing (polymerization) and drying can occur. The drying technique may also affect the thin film morphology and uniformity.

The partially polymerized material should have sufficient increase in the molecular weight to increase the viscosity, and therefore improve the stability of a homogenous composition that results from the partial polymerization. The partially polymerized material should also have a low enough extent of cure to enable the homogenous composition to “collapse” upon removal of the major portion of the solvent, i.e., the homogenous composition does not retain sufficient structure after removal of the solvent to form substantial pores or voids upon removal of the solvent. In one particular embodiment, the homogeneous composition includes a polymer gel. For the purposes of this application, a polymer gel is a polymer network that is expanded throughout its whole volume by a fluid (in this case the solvent), but is not self-supporting after removal of the solvent. Generally, the homogenous composition according to the present disclosure should be partially polymerized only to the extent that viscosity increases, and before a self-supporting insoluble polymer network can be formed in the coating.

In some embodiments, the partial polymerization is permitted to proceed to the extent where an insoluble polymeric matrix is formed, and can result in a self-supporting structure. A description of this similar process, useful to form a coating having pores and voids, is described, for example, in co-pending Attorney Docket No. 65046US002, entitled PROCESS AND APPARATUS FOR A NANOVOIDED ARTICLE, filed on an even date herewith. Several exemplary nanovoided articles and uses for the nanovoided articles can be found, for example, in co-pending Attorney Docket Nos. 65062US002, entitled OPTICAL FILM; 65357US002, entitled BACKLIGHT AND DISPLAY SYSTEM INCORPORATING SAME; 65356US002, entitled OPTICAL FILM FOR PREVENTING OPTICAL COUPLING; 65354US002, entitled OPTICAL CONSTRUCTION AND DISPLAY SYSTEM INCORPORATING SAME; and 65355US002, entitled RETROREFLECTING OPTICAL CONSTRUCTION, all filed on an even date herewith. The use of the nanovoided article can be dependent on the mechanical properties of the polymer matrix. In one particular embodiment, the polymer matrix modulus and strength are sufficient to maintain a void space as the solvent is removed.

In some embodiments, the process for creating the polymeric coatings generally includes 1) supplying the solution to a coating device; 2) applying the coating solution to a substrate by one of many coating techniques; 3) transporting the coated substrate to a partial polymerization apparatus (the environment can be controlled to deliver the thin film coating at the desired composition); 4) optionally removing a minor portion of the solvent in the coating solution; 5) at least partially polymerizing while solvent is present within the coating (the polymerization can be performed in ambient conditions or in controlled environments); 6) optionally supplying conditioned gas upstream, downstream, or within the partial polymerization apparatus to control the polymerization environment; 7) transporting the polymerized coating to drying equipment (drying can naturally occur during this transport step unless equipment is in place to prevent it); 8) drying the polymerized coating; and 9) polymerizing the dried polymerized coating, for example, by additional thermal, visible, UV, or EB curing.

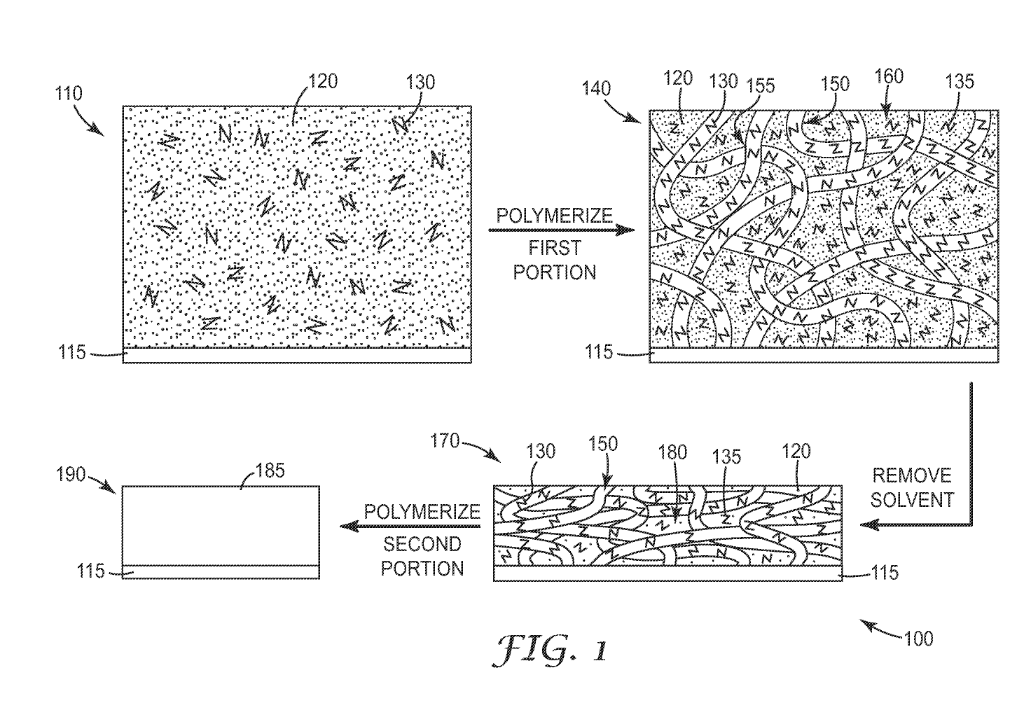

FIG. 1 shows a schematic view of a process 100 for a polymer coating 190 formed on a substrate 115, according to one aspect of the disclosure. A first solution 110 that includes a polymerizable material 130 in a solvent 120 is provided. The first solution 120 is coated on a substrate 115. A first portion of the polymerizable material 130 in the first solution 110 is at least partially polymerized to form a homogeneous composition 140 on the substrate 115, where the homogeneous composition 140 includes the partially polymerized material 150 in a second solution 160. A major portion of the solvent 120 is removed from the second solution 160 to form a homogeneous coating 170 on the substrate 115, where the homogeneous coating 170 includes the partially polymerized material 150 in a third solution 180. A second portion of the polymerizable material 135 is polymerized to form the polymer coating 190, including the homogenous film 185 on the substrate 115.

As used herein, by the term “homogenous” is meant uniform in structure or composition throughout, on a macro-scale (i.e. across the width, length, and depth of the solution, coating or film). One portion of a homogeneous solution, coating or film is invariant from another portion of the homogenous solution, coating or film. For example, a homogeneous solution can include discrete particles, polymer chains, monomers and solvent in the solution, but one portion of the solution may not be distinguished from another portion of the solution. Also, for example, a homogeneous coating can include discrete particles, polymer chains, monomers and solvent in the coating, but one portion of the coating may not be distinguished from another portion of the coating; and further, the thickness of the coating in one portion of the coating may not be distinguished from another portion of the coating. Also, for example, a homogeneous film can include discrete particles and polymer chains in the film, but one portion of the coating cannot be distinguished from another portion of the coating; and further, the thickness of one portion of the coating may not be distinguished from another portion of the coating.

Polymerizable material 130 can be any polymerizable material that can be polymerized by various conventional cationic or free radical polymerization techniques, which can be chemical, thermal, or radiation initiated, including, e.g., solvent polymerization, emulsion polymerization, suspension polymerization, bulk polymerization, and radiation polymerization, including, e.g., processes using actinic radiation including, e.g., visible and ultraviolet light, electron beam radiation, and the like, and combinations thereof.

Actinic radiation curable materials include monomers, oligomers, and polymers of acrylates, methacrylates, urethanes, epoxies and the like. Representative examples of energy curable groups suitable in the practice of the present disclosure include epoxy groups, (meth)acrylate groups, olefinic carbon-carbon double bonds, allyloxy groups, alpha-methyl styrene groups, (meth)acrylamide groups, cyanate ester groups, vinyl ethers groups, combinations of these, and the like. Free radically polymerizable groups are preferred. In some embodiments, exemplary materials include acrylate and methacrylate monomers, and in particular, multifunctional monomers that can form a crosslinked network upon polymerization can be used, as known in the art. The polymerizable materials can include any mixture of monomers, oligomers and polymers; however the materials must be at least partially soluble in at least one solvent. In some embodiments, the materials should be soluble in the solvent monomer mixture.

As used herein, the term “monomer” means a relatively low molecular weight material (i.e., having a molecular weight less than about 500 g/mole) having one or more energy polymerizable groups. “Oligomer” means a relatively intermediate molecular weight material having a molecular weight of from about 500 up to about 10,000 g/mole. “Polymer” means a relatively high molecular weight material having a molecular weight of at least about 10,000 g/mole, preferably at 10,000 to 100,000 g/mole. The term “molecular weight” as used throughout this specification means number average molecular weight unless expressly noted otherwise.

Exemplary monomeric polymerizable materials include styrene, alpha-methylstyrene, substituted styrene, vinyl esters, vinyl ethers, N-vinyl-2-pyrrolidone, (meth)acrylamide, N-substituted (meth)acrylamide, octyl(meth)acrylate, iso-octyl(meth)acrylate, nonylphenol ethoxylate (meth)acrylate, isononyl(meth)acrylate, diethylene glycol (meth)acrylate, isobornyl(meth)acrylate, 2-(2-ethoxyethoxy)ethyl (meth)acrylate, 2-ethylhexyl(meth)acrylate, lauryl(meth)acrylate, butanediol mono(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl (meth)acrylate, methyl(meth)acrylate, hexyl(meth)acrylate, (meth)acrylic acid, N-vinylcaprolactam, stearyl(meth)acrylate, hydroxy functional polycaprolactone ester (meth)acrylate, hydroxyethyl(meth)acrylate, hydroxymethyl(meth)acrylate, hydroxypropyl(meth)acrylate, hydroxyisopropyl(meth)acrylate, hydroxybutyl (meth)acrylate, hydroxyisobutyl(meth)acrylate, tetrahydrofurfuryl(meth)acrylate, combinations of these, and the like.

Oligomers and polymers may also be collectively referred to herein as “higher molecular weight constituents or species.” Suitable higher molecular weight constituents may be incorporated into compositions of the present disclosure to provide many benefits, including viscosity control, reduced shrinkage upon curing, durability, flexibility, adhesion to porous and nonporous substrates, outdoor weatherability, and/or the like. The amount of oligomers and/or polymers incorporated into fluid compositions of the present disclosure may vary within a wide range depending upon such factors as the intended use of the resultant composition, the nature of the reactive diluent, the nature and weight average molecular weight of the oligomers and/or polymers, and the like. The oligomers and/or polymers themselves may be straight-chained, branched, and/or cyclic. Branched oligomers and/or polymers tend to have lower viscosity than straight-chain counterparts of comparable molecular weight.

Exemplary polymerizable oligomers or polymers include aliphatic polyurethanes, acrylics, polyesters, polyimides, polyamides, epoxy polymers, polystyrene (including copolymers of styrene) and substituted styrenes, silicone containing polymers, fluorinated polymers, combinations of these, and the like. For some applications, polyurethane and acrylic-containing oligomers and/or polymers can have improved durability and weatherability characteristics. Such materials also tend to be readily soluble in reactive diluents formed from radiation curable, (meth)acrylate functional monomers.

Because aromatic constituents of oligomers and/or polymers generally tend to have poor weatherability and/or poor resistance to sunlight, aromatic constituents can be limited to less than 5 weight percent, preferably less than 1 weight percent, and can be substantially excluded from the oligomers and/or polymers and the reactive diluents of the present disclosure. Accordingly, straight-chained, branched and/or cyclic aliphatic and/or heterocyclic ingredients are preferred for forming oligomers and/or polymers to be used in outdoor applications.

Suitable radiation curable oligomers and/or polymers for use in the present disclosure include, but are not limited to, (meth)acrylated urethanes (i.e., urethane (meth)acrylates), (meth)acrylated epoxies (i.e., epoxy (meth)acrylates), (meth)acrylated polyesters (i.e., polyester (meth)acrylates), (meth)acrylated (meth)acrylics, (meth)acrylated silicones, (meth)acrylated polyethers (i.e., polyether (meth)acrylates), vinyl(meth)acrylates, and (meth)acrylated oils.

Solvent 120 can be any solvent that forms a solution with the desired polymerizable material 130. The solvent can be a polar or a non-polar solvent, a high boiling point solvent or a low boiling point solvent, and a mixture of several solvents may be preferred. The solvent or solvent mixture may be selected so that the partially polymerized material 150 remains soluble in the solvent (or at least one of the solvents in a solvent mixture) in the homogeneous composition 140. In some embodiments, the solvent mixture can be a mixture of a solvent and a non-solvent for the polymerizable material 130. In one particular embodiment, a minor portion of solvent 120 can be removed from the solution after coating, but before polymerization begins. In another embodiment, a minor portion of solvent 120 can be removed during the polymerization step. By “minor portion” is means a small enough amount so that the first solution 110 remains stable prior to partial polymerization of the homogeneous composition 140. The minor portion can be less than about 30%, less than about 20%, less than about 10%, less than about 5%, or less than about 2%, of the solvent 120 in first solution 110.

During polymerization, the first solution 110 separates to form a homogeneous composition 140, that includes the second solution 160 and a polymer-rich solution that polymerizes to form the partially polymerized material 150. The second solution 160 is depleted of the polymerizable material 130; however a second portion of the polymerizable material 135 remains in the second solution 160. The homogeneous composition 140 generally has a higher viscosity than the first solution 110, and is less subject to disturbances in the coating environment, as described elsewhere. The partially polymerized material 150 forms polymer chains that can extend throughout the homogenous composition 140, as shown in FIG. 1. The polymer chains can physically cross and/our come in contact with each other in regions 155; however, generally no chemical bonds (e.g. crosslinks) form between the chains in the homogenous composition 140.

In one embodiment, solvent 120 can be easily removed from the homogeneous composition 140 by drying, for example, at temperatures not exceeding the decomposition temperature of either the partially polymerized material 150, or the substrate 115. In one particular embodiment, the temperature during drying is kept below a temperature at which the substrate 115 is prone to deformation, e.g., a warping temperature of the substrate 115, or a glass-transition temperature of the substrate 115. Exemplary solvents include linear, branched, and cyclic hydrocarbons, alcohols, ketones, and ethers, including for example, propylene glycol ethers such as DOWANOL™ PM propylene glycol methyl ether; isopropyl alcohol, ethanol, toluene, ethyl acetate, 2-butanone, butyl acetate, methyl isobutyl ketone, water, methyl ethyl ketone, cyclohexanone, acetone, aromatic hydrocarbons; isophorone; butyrolactone; N-methylpyrrolidone; tetrahydrofuran; esters such as lactates, acetates, propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate), iso-alkyl esters, isohexyl acetate, isoheptyl acetate, isooctyl acetate, isononyl acetate, isodecyl acetate, isododecyl acetate, isotridecyl acetate or other iso-alkyl esters; combinations of these and the like.

The first solution 110 can also include other ingredients including, e.g., initiators, curing agents, cure accelerators, catalysts, crosslinking agents, tackifiers, plasticizers, dyes, surfactants, flame retardants, coupling agents, pigments, impact modifiers including thermoplastic or thermoset polymers, flow control agents, foaming agents, fillers, glass and polymer microspheres and microparticles, other particles including electrically conductive particles, thermally conductive particles, fibers, antistatic agents, antioxidants, UV absorbers, and the like.

An initiator, such as a photoinitiator, can be used in an amount effective to facilitate polymerization of the monomers present in the first solution 110. The amount of photoinitiator can vary depending upon, for example, the type of initiator, the molecular weight of the initiator, the intended application of the resulting partially polymerized material 150 and the polymerization process including, e.g., the temperature of the process and the wavelength of the actinic radiation used. Useful photoinitiators include, for example, those available from Ciba Specialty Chemicals under the IRGACURE™ and DAROCURE™ trade designations, including IRGACURE™ 184 and IRGACURE™ 819.

In some embodiments, a mixture of initiators and initiator types can be used, for example to control the polymerization in different sections of the process. In one embodiment, optional post-processing polymerization may be a thermally initiated polymerization that requires a thermally generated free-radical initiator. In other embodiments, optional post-processing polymerization may be an actinic radiation initiated polymerization that requires a photoinitiator. The post-processing photoinitiator may be the same or different than the photoinitiator used to polymerize the polymer matrix in solution.

The partially polymerized material 150 may be cross-linked to provide a more rigid polymer coating 185. In one particular embodiment, the partially polymerized material 150 retains sufficient mobility to at least partially collapse, upon removal of the solvent 120, and not form a rigid three-dimensional polymer network that resists deformation. Cross-linking can be achieved with or without a cross-linking agent by using high energy radiation such as gamma or electron beam radiation. In some embodiments, a cross-linking agent or a combination of cross-linking agents can be added to the mixture of polymerizable monomers. The cross-linking can occur during polymerization of the polymer network using any of the actinic radiation sources described elsewhere.

Useful radiation curing cross-linking agents include multifunctional acrylates and methacrylates, such as those disclosed in U.S. Pat. No. 4,379,201 (Heilmann et al.), which include 1,6-hexanediol di(meth)acrylate, trimethylolpropane tri(meth)acrylate, 1,2-ethylene glycol di(meth)acrylate, pentaerythritol tri/tetra(meth)acrylate, triethylene glycol di(meth)acrylate, ethoxylated trimethylolpropane tri(meth)acrylate, glycerol tri(meth)acrylate, neopentyl glycol di(meth)acrylate, tetraethylene glycol di(meth)acrylate, 1,12-dodecanol di (meth)acrylate, copolymerizable aromatic ketone co-monomers such as those disclosed in U.S. Pat. No. 4,737,559 (Kellen et al.) and the like, and combinations thereof.

The first solution 110 may also include a chain transfer agent. The chain transfer agent is preferably soluble in the monomer mixture prior to polymerization. Examples of suitable chain transfer agents include triethyl silane and mercaptans. In some embodiments, chain transfer can also occur to the solvent; however this may not be a preferred mechanism.

The polymerizing step preferably includes using a radiation source in an atmosphere that has a low oxygen concentration. Oxygen is known to quench free-radical polymerization, resulting in diminished extent of cure. The radiation source used for achieving polymerization and/or crosslinking may be actinic (e.g., radiation having a wavelength in the ultraviolet or visible region of the spectrum), accelerated particles (e.g., electron beam radiation), thermal (e.g., heat or infrared radiation), or the like. In some embodiments, the energy is actinic radiation or accelerated particles, because such energy provides excellent control over the initiation and rate of polymerization and/or crosslinking. Additionally, actinic radiation and accelerated particles can be used for curing at relatively low temperatures. This avoids degrading or evaporating components that might be sensitive to the relatively high temperatures that might be required to initiate polymerization and/or crosslinking of the energy curable groups when using thermal curing techniques. Suitable sources of curing energy include UV LEDs, visible LEDs, lasers, electron beams, mercury lamps, xenon lamps, carbon arc lamps, tungsten filament lamps, flashlamps, sunlight, low intensity ultraviolet light (black light), and the like.

A major portion of the solvent 120 is removed in the solvent removal step to produce the homogeneous coating 170. By a major portion of the solvent 120 is meant greater than 90%, 80%, 70%, 60%, or greater than 50% by weight of the solvent. Solvent 120 can be removed by drying in a thermal oven that can include air floatation/convection, drying with infrared or other radiant light sources, vacuum drying, gap drying, or a combination of drying techniques. The choice of drying technique can be governed by the desired process speed, extent of solvent removal, and expected coating morphology, among others. In one particular embodiment, gap drying can offer advantages for solvent removal, as gap drying can offer rapid drying within minimal space.

After removing a major portion of the solvent 120, the homogeneous coating 170 includes the partially polymerized material 150 from first portion of polymerizable material 130, and a third solution 180. The third solution 180 includes a second portion of the polymerizable material 135 and optionally residual solvent 120. The homogeneous coating 170 is then further polymerized to form the polymer coating 190 on substrate 115, by polymerizing a second portion of the polymerizable material 135. This polymerization can be accomplished using any of the actinic radiation sources described elsewhere.

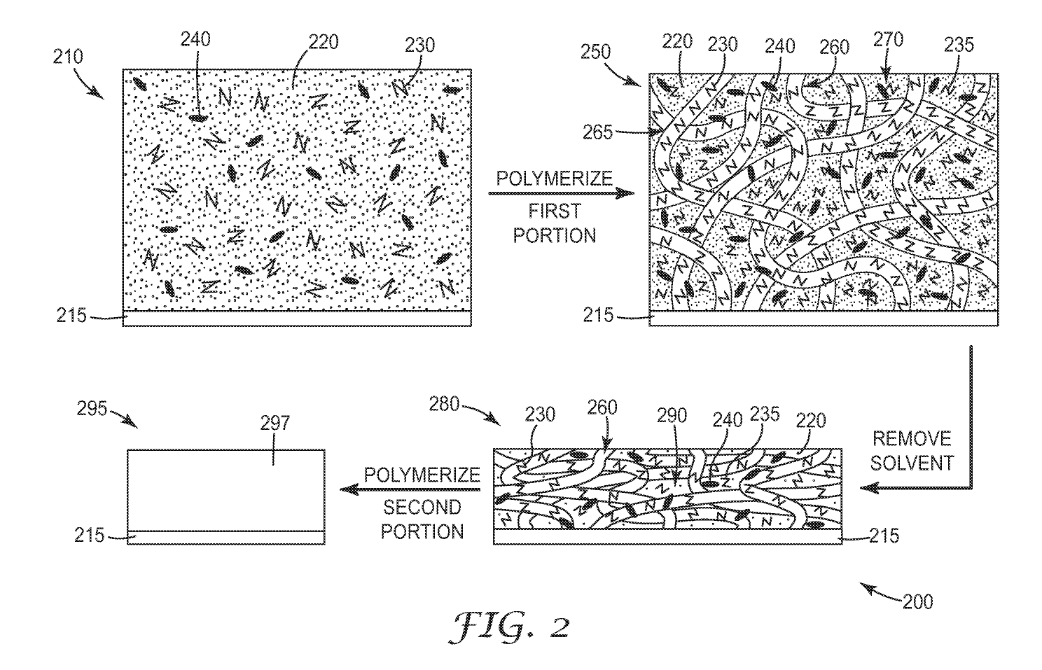

FIG. 2 shows a schematic view of a process 200 for forming a particulate-loaded polymer coating 295 on a substrate 215 according to another aspect of the disclosure. A first solution 210 that includes a polymerizable material 230 and particles 240 in a solvent 220 is coated on a substrate 215. The first solution 210 is at least partially polymerized to form a homogeneous composition 250 including the particles 240 bound to a partially polymerized material 260 in a second solution 270. A major portion of the solvent 220 from the second solution 270 is removed to form the homogenous coating 280 on the substrate 115, where the homogeneous coating 280 includes the partially polymerized material 260 in a third solution 290. A second portion of the polymerizable material 235 is polymerized to form the polymer coating 295, including a homogenous film 297 on the substrate 115.

The second solution 270 is depleted of the polymerizable material 230; however a second portion of the polymerizable material 235 remains in the second solution 270. The homogeneous composition 250 generally has a higher viscosity than the first solution 210, and is less subject to disturbances in the coating environment. The partially polymerized material 260 forms polymer chains that can extend throughout the homogenous composition 250, as shown in FIG. 2. The polymer chains can physically cross and/our come in contact with each other in regions 265; however, generally no chemical bonds (e.g. crosslinks) form between the polymer chains in the homogenous composition 250.

The second solution 270 can also include a portion of particles 245 that are not bound to the partially polymerized material 260, as shown in FIG. 2 (i.e., the second solution 270 may have become depleted of particles 240, but some may still be present). As used herein, particles 240 “bound to” the partially polymerized material 260 is meant to include particles completely embedded in the partially polymerized material, particles partially embedded in the partially polymerized material, particles attached to the surface of the partially polymerized material, or a combination thereof.

Particles 240 can be made from any desired material, and can have any size, but are generally smaller than the thickness of the coated first solution 210. In one particular embodiment, particles 240 can be polymeric beads, such as acrylate beads or styrene beads, which are dispersed uniformly throughout the coated first solution 210. Partial polymerization of the polymerizable material can prevent movement or agglomeration of the beads in the coating during cure, as described elsewhere. In one particular embodiment, particles 240 can be nanoparticles, including surface modified reactive nanoparticles that are chemically bound to the partially polymerized material 260. In one particular embodiment, particles 240 can instead be surface modified non-reactive nanoparticles that are physically bound to the partially polymerized material 260.

The polymerizable material 230 and solvent 220 can be the same as described for polymerizable material 130 and solvent 120, respectively, of FIG. 1. In one embodiment, the particles 240 can be inorganic particles, organic (e.g., polymeric) particles, or a combination of organic and inorganic particles. In one particular embodiment, particles 240 can be porous particles, hollow particles, solid particles, or a combination thereof. Examples of suitable inorganic particles include silica and metal oxide particles including zirconia, titania, ceria, alumina, iron oxide, vanadia, antimony oxide, tin oxide, alumina/silica, and combinations thereof. The particles can have an average particle diameter less than the first solution coating thickness, generally less than about 1000 microns. In one particular embodiment, the particles can be nanoparticles having an average particle diameter less than 1000 nm, less than about 100 nm less than about 50 nm, or from about 3 nm to about 50 nm. In some embodiments, the nanoparticles can have an average particle diameter from about 3 nm to about 50 nm, or from about 3 nm to about 35 nm, or from about 5 nm to about 25 nm. If the nanoparticles are aggregated, the maximum cross sectional dimension of the aggregated particle can be within any of these ranges, and can also be greater than about 100 nm. In some embodiments, “fumed” nanoparticles, such as silica and alumina, with primary size less than about 50 nm, are also included, such as CAB-O-SPERSE® PG 002 fumed silica, CAB-O-SPERSE® 2017A fumed silica, and CAB-O-SPERSE® PG 003 fumed alumina, available from Cabot Co. Boston, Mass.

In some embodiments, the particles 240 include surface groups selected from the group consisting of hydrophobic groups, hydrophilic groups and combinations thereof. In other embodiments, the particles include surface groups derived from an agent selected from the group consisting of a silane, organic acid, organic base and combinations thereof. In other embodiments, the particles include organosilyl surface groups derived from an agent selected from the group consisting of alkylsilane, arylsilane, alkoxysilane, and combinations thereof.

The term “surface-modified particle” refers to a particle that includes surface groups attached to the surface of the particle. The surface groups modify the character of the particle. The terms “particle diameter” and “particle size” refer to the maximum cross-sectional dimension of a particle. If the particle is present in the form of an aggregate, the terms “particle diameter” and “particle size” refer to the maximum cross-sectional dimension of the aggregate. In some embodiments, particles can be large aspect ratio agglomerates of nanoparticles, such as fumed silica particles.

The surface-modified particles have surface groups that can modify the solubility characteristics of the particles. The surface groups are generally selected to render the particle compatible with the polymerizable first solution 210. In one embodiment, the surface groups can be selected to associate or react with at least one component of the first solution 210, to become a chemically bound part of the partially polymerized material 260.

A variety of methods are available for modifying the surface of particles including, e.g., adding a surface modifying agent to particles (e.g., in the form of a powder or a colloidal dispersion) and allowing the surface modifying agent to react with the particles. Other useful surface modification processes are described in, e.g., U.S. Pat. Nos. 2,801,185 (Iler) and 4,522,958 (Das et al.), and incorporated herein.

Useful surface-modified silica nanoparticles include silica nanoparticles surface-modified with silane surface modifying agents including, e.g., Silquest® silanes such as Silquest® A-1230 from GE Silicones, 3-acryloyloxypropyl trimethoxysilane, 3-methacryloyloxypropyltrimethoxysilane, 3-mercaptopropyltrimethoxysilane, n-octyltrimethoxysilane, isooctyltrimethoxysilane, 4-(triethoxysilyl)-butyronitrile, (2-cyanoethyl)triethoxysilane, N-(3-triethoxysilylpropyl)methoxyethoxyethoxyethyl carbamate (PEG3TMS), N-(3-triethoxysilylpropyl)methoxyethoxyethoxyethyl carbamate (PEG2TMS), 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy)propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, and combinations thereof. Silica nanoparticles can be treated with a number of surface modifying agents including, e.g., alcohol, organosilane including, e.g., alkyltrichlorosilanes, trialkoxyarylsilanes, trialkoxy(alkyl)silanes, and combinations thereof and organotitanates and mixtures thereof.

Nanoparticles may be provided in the form of a colloidal dispersion. Examples of useful commercially available unmodified silica starting materials include nano-sized colloidal silicas available under the product designations NALCO 1040, 1050, 1060, 2326, 2327, and 2329 colloidal silica from Nalco Chemical Co., Naperville, Ill.; the organosilica under the product name IPA-ST-MS, IPA-ST-L, IPA-ST, IPA-ST-UP, MA-ST-M, and MA-ST sols from Nissan Chemical America Co. Houston, Tex. and the SnowTex® ST-40, ST-50, ST-20L, ST-C, ST-N, ST-O, ST-OL, ST-ZL, ST-UP, and ST-OUP, also from Nissan Chemical America Co. Houston, Tex. The weight ratio of polymerizable material to nanoparticles can range from about 30:70, 40:60, 50:50, 55:45, 60:40, 70:30, 80:20 or 90:10 or more. The preferred ranges of wt % of nanoparticles range from about 10% by weight to about 50% by weight, and can depend on the mass of the nanoparticle used.

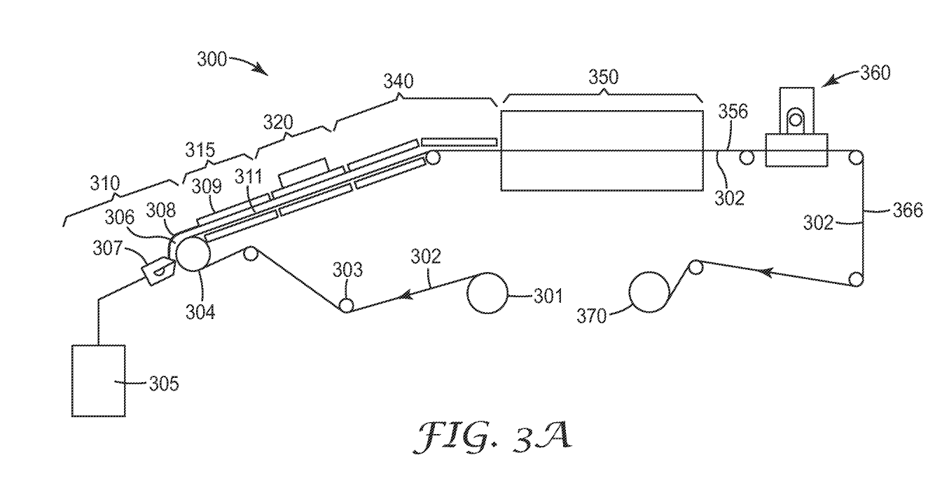

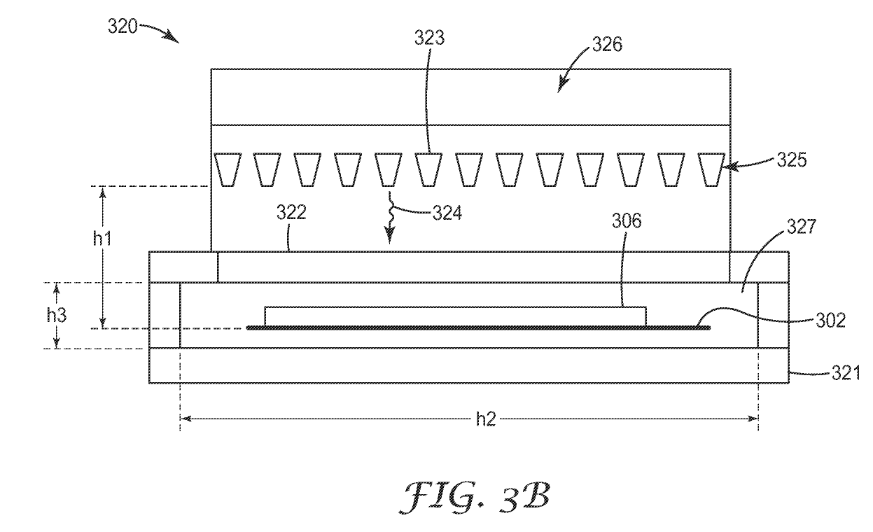

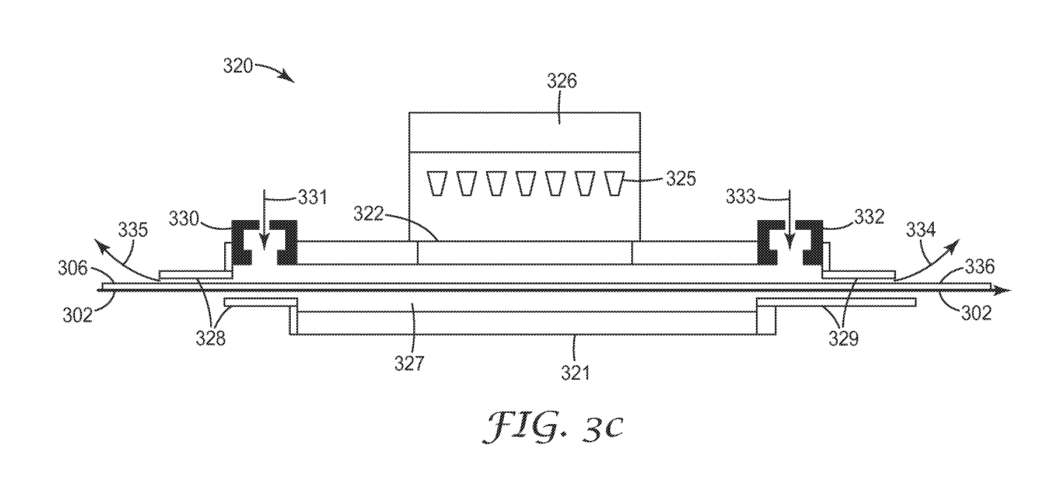

FIG. 3A shows a schematic view of a process 300 for forming a homogeneous coating 356 on a substrate 302, according to one aspect of the disclosure. The process 300 shown in FIG. 3A is a continuous process, although it is to be understood that the process can instead be performed in a stepwise manner, i.e., the steps of coating, polymerizing, and removing solvent described below can be performed on individual substrate pieces in discrete operations, to form the homogeneous coating 356.

The process 300 shown in FIG. 3A passes a substrate 302 through a coating section 310, an optional coating conditioning section 315, a polymerization section 320, a first solvent removal section 340, and an second solvent removal section 350 to form the homogeneous coating 356 on the substrate 302. Homogeneous coating 356 on substrate 302 then passes through second polymerization section 360 to form a polymer coating 366 on the substrate 302, which is then wound up as an output roll 370. In some embodiments, process 300 can include additional processing equipment common to the production of web-based materials, including, for example, idler rolls; tensioning rolls; steering mechanisms; surface treaters such as corona or flame treaters; lamination rolls; and the like. In some embodiments, the process 300 can utilized different web paths, coating techniques, polymerization apparatus, positioning of polymerization apparatus, drying ovens, conditioning sections, and the like, and some of the sections described can be optional.

The substrate 302 can be any known substrate suitable for roll-to-roll web processing in a webline, including, for example, polymeric substrates, metalized polymeric substrates, metal foils, combinations thereof, and the like. In one particular embodiment, the substrate 302 is an optical quality polymeric substrate, suitable for use in an optical display such as a liquid crystal display.

The substrate 302 is unwound from an input roll 301, passes over idler rolls 303 and contacts coating roll 304 in coating section 310. A first solution 305 passes through a coating die 307 to form a first coating 306 of first solution 305 on substrate 302. The first solution 305 can include solvents, polymerizable materials, optional particles, photoinitiators, and any of the other first solution components described elsewhere. A shroud 308 positioned between the coating die 307 in the coating section 310, and a coating conditioning region 309 in the coating conditioning section 315, can provide a first controlled environment 311 surrounding the first solution 305. In some embodiments, the shroud 308 and coating conditioning section 315 can be optional, for example, when the polymerization occurs before substantial change can occur in the composition of the first solution 305. The substrate 302 having the first coating 306 of first solution 305 then enters the polymerization section 320 where the first solution 305 is polymerized, as described elsewhere.

The coating die 307 can include any known coating die and coating technique, including multilayer coating, and is not to be limited to any specific die design or technique of coating thin films. Examples of coating techniques include knife coating, gravure coating, slide coating, slot coating, slot-fed knife coating, curtain coating, and the like as known to those skilled in the art. Several applications of the polymer coating can include the need for precise thickness and defect-free coatings, and may require the use of a precise slot coating die 307 positioned against a precision coating roll 304 as shown in FIG. 3A. The first coating 306 can be applied at any thickness; however thin coatings are preferred, for example coatings less than 1000 microns thick, less than about 500 microns thick, less than about 100 microns thick, or less than about 50 microns thick can provide polymer coatings having exemplary properties.

Because the first coating 306 includes at least one solvent and a polymerizable material as described elsewhere, the shroud 308 is positioned to reduce any undesired loss of solvent from the coating, protect the coating from ambient air currents, and also to protect the coating from oxygen which can inhibit the polymerization. The shroud 308 can be, for example, a formed aluminum sheet that is positioned in close proximity to the first coating 306 and provides a seal around the coating die 307 and the coating roll 304 so that the first controlled environment 311 can be maintained. In some embodiments, the shroud 308 can also serve to protect the coating from ambient room conditions. The first controlled environment 311 can include inerting gases such as nitrogen to control oxygen content, solvent vapors to reduce the loss of solvent, or a combination of inert gases and solvent vapors. The oxygen concentration can affect both the rate and extent of polymerization, so in one embodiment, the oxygen concentration in the first controlled environment 311 is reduced to less than 1000 parts-per-million (ppm), less than 500 ppm, less than 300 ppm, less than 150 ppm, less than 100 ppm, or even less than 50 ppm. Generally, the lowest oxygen concentration that can be attained is preferred.

The coating conditioning region 309 in the coating conditioning section 315 is an extension of the shroud 308 that provides additional capabilities to modify the first coating 306 before entering the polymerization section 320. The first controlled environment 311 can still be maintained within coating conditioning region 309. In other embodiments, additional heating, cooling, or input and exhaust gases can be provided to adjust or maintain the composition of the first coating 306. For example, solvent vapor can be introduced in the input gas to reduce evaporation of solvent from the first coating 306 prior to polymerization.

A heating apparatus, such as a gap dryer described, for example, in U.S. Pat. No. 5,694,701 can be used to raise or lower the temperature of first coating 306, drive off additional solvent to adjust the composition of first coating 306, or both. The gap dryer could also be used to remove a portion of the solvent before the polymerization section to enable the desired thin film morphology and composition, for example, when the optimum composition of the coating (e.g., % solids) is different from the optimum composition for polymerization. Often, coating conditioning region 309 can serve to provide additional time for the first coating 306 to stabilize, for example, to smooth any surface ripples or streaks, prior to polymerization.

FIG. 3B is a schematic view of the polymerization section 320 of process 300 shown in FIG. 3A, according to one aspect of the disclosure. FIG. 3B shows a cross-section of the polymerization section 320 as viewed down the path of the substrate 302. Polymerization section 320 includes a housing 321 and a quartz plate 322 that provide boundaries of a second controlled environment 327 that partially surrounds the first coating 306 on substrate 302. A radiation source 323 generates actinic radiation 324 that passes through quartz plate 322 and polymerizes the first coating 306 on substrate 302. Instead of a single radiation source 323, a radiation source array 325 shown in FIG. 3B can provide improved uniformity and rate of polymerization to the polymerization process. The radiation source array 325 can provide individual control of radiation source 323, for example, crossweb or downweb profiles can be generated as desired. A heat extractor 326 can be positioned to control the temperature by removing heat generated by each radiation source 323 in the radiation source array 325.

The housing 321 can be a simple enclosure designed to surround the substrate 302, first coating 306, and a homogeneous solution coating 336 (shown in FIG. 3C), or the housing 321 can also include additional elements, such as, for example, temperature controlled plates (not shown) that can adjust the temperature of a second controlled environment 327. The housing 321 has sufficient interior dimensions “h3” and “h2” to enclose substrate 302 and first coating 306 to provide the second controlled environment 327. The gas flow fields impact inerting capabilities, coating composition, coating uniformity, and the like. As shown in FIG. 3B, the housing 321 includes a top quartz plate 322 separating the second controlled environment 327 from radiation source 323 in radiation source array 325. The radiation source array 325 is positioned a distance “h1” from the substrate 302 to provide uniform actinic radiation 324 to the first coating 306. In one embodiment, “h1” and “h3” are 1 inch (2.54 cm) and 0.25 inch (0.64 cm), respectively. In some embodiments (not shown), the polymerization section 320 can be inverted so that the quartz plate 322 and radiation source 323 are located beneath the substrate 302, and actinic radiation 324 passes through the substrate 302 before polymerizing first coating 306. In other embodiments (also not shown), the polymerization section 320 can include two quartz plates 322 and two radiation sources 323, located above and below the substrate, to polymerize first coating 306.

The radiation source 323 can be any source of actinic radiation as described elsewhere. In some embodiments, radiation source 323 is an ultraviolet LED that is capable of producing UV radiation. A combination of radiation sources emitting at different wavelengths can be used to control the rate and extent of the polymerization reaction. The UV-LEDs or other radiation sources can generate heat during operation, and the heat extractor 326 can be fabricated from aluminum that is cooled by either air or water to control the temperature by removing the generated heat.

FIG. 3C is a schematic view of the polymerization section 320 of process 300 shown in FIG. 3A, according to one aspect of the disclosure. FIG. 3C shows a cross-section of the polymerization section 320 as viewed along an edge of the substrate 302. Polymerization section 320 includes the housing 321 and the quartz plate 322 that provide boundaries of the second controlled environment 327. The second controlled environment 327 partially surrounds the first coating 306 and the homogeneous solution coating 336 on substrate 302. Homogeneous solution coating 336 includes partially polymerized material, as described elsewhere.

The second controlled environment 327 will now be described. Housing 321 includes an entrance aperture 328 and an exit aperture 329 that can be adjusted to provide any desired gap between the substrate 302, the coating 306 on substrate 302, and the respective aperture. The second controlled environment 327 can be maintained by control of the temperature of the housing 321, and appropriate control of the temperature, composition, pressure and flow rate of a first input gas 331, a second input gas 333, a first output gas 335 and a second output gas 334. Appropriate adjustment of the sizes of the entrance and exit apertures 328, 329 can aid control of the pressure and flow rate of the first and second output gases 335, 334, respectively.

The first output gas 335 can flow from the second controlled environment 327 through the entrance aperture 328 and into the first controlled environment 311 of coating conditioning section 315, shown in FIG. 3A. In some embodiments, the pressure within the second controlled environment 327 and the first controlled environment 311 are adjusted to prevent pressure driven flow between the two environments, and first output gas 335 can exit second controlled environment 327 from another location (not shown) within housing 321. The second output gas 334 can flow from the second controlled environment 327 through the exit aperture 329, and into the first solvent removal section 340 shown in FIG. 3A, or the second output gas 334 can exit second controlled environment 327 from another location (not shown) within housing 321.

A first input gas manifold 330 is positioned adjacent the housing 321 proximate the entrance aperture 328, to distribute the first input gas 331 with desired uniformity across the width of the first coating 306. A second input gas manifold 332 is positioned adjacent the housing 321 proximate the exit aperture 329, to distribute the second input gas 333 with desired uniformity across the width of the homogeneous solution coating 336. First and second input gases 331, 333 can be distributed above the web, below the web, or in any combination of above and below the web, as desired. First and second input gases 331, 333 can be the same or they can be different, and can include inerting gasses such as nitrogen, which can reduce oxygen concentration that can inhibit the polymerization reaction, as is known. First and second input gases 331, 333 can also include solvent vapors that can help reduce the loss of solvent from first coating 306 before or during polymerization, as described elsewhere. The relative flow rates, flow velocities, flow impingement or orientation on the coating, and temperature of each of the first and second input gases 331, 333 can be controlled independently, and can be adjusted to reduce imperfections in the first coating 306 prior to polymerization. The imperfections can be caused by disturbances to the coating, as known in the art. In some cases, only one of the first and second input gases 331, 333 may be flowing.

Returning now to FIG. 3A, the remainder of the process will be described. After leaving polymerization section 320, homogeneous solution coating 336 on substrate 302 enters first solvent removal section 340. First solvent removal section 340 can be a conventional drying oven that removes solvent by heating the homogeneous solution coating 336 to evaporate the solvent. A preferred solvent removal section 340 is a gap dryer, such as described for example in U.S. Pat. Nos. 5,694,701 and 7,032,324. A gap dryer can provide greater control of the drying environment, which may be desired in some applications. A second solvent removal section 350 can then be used to ensure that a major portion of the solvent is removed.

A homogeneous coating 356 on substrate 302 exits second solvent removal section 350 and then passes through second polymerization section 360 to form a polymer coating 366 on the substrate 302. In one particular embodiment, second polymerization section 360 can be optional, for example if the homogeneous coating 356 has been sufficiently cured to form the polymer coating 366 in the previous steps of the process. Second polymerization section 360 can include any of the actinic radiation sources previously described, to fully cure the homogeneous coating 356. In some embodiments, increasing the extent of cure can include polymerizing remaining polymerizable material (i.e., remaining polymerizable material 135, shown in FIG. 1) after removal of the solvent. Homogeneous coating 356 on substrate 302 exits second polymerization section 360 and is then wound up as an output roll 370. In some embodiments, output roll 370 can have other desired films (not shown) laminated to the coating and simultaneously wound on the output roll 370. In other embodiments, additional layers (not shown) can be coated, cured, and dried on either the homogeneous coating 356 or the substrate 302.

### EXAMPLES

The following list of materials and their source is referred to throughout the Examples.

| | |
|---|---|
| Nalco 2327 - colloidal silica dispersion | Nalco Co. Naperville IL |
| ATO—antimony tin oxide (participate) | Inframat Advanced Materials, Farmington CT |
| MX-300 - acrylic beads | Soken Chemical and Engineering Co, Tokyo JP |
| Trimethoxy (2,4,4 trimethypentyl) silane | Aldrich Chemical, Milwaukee WI |
| 3-(Triethoxysilyl) propionitrile | Aldrich Chemical, Milwaukee WI |
| 3-(Methacryloyloxy)propyltrimethoxy silane | Aldrich Chemical, Milwaukee WI |
| Solplus ® D-510 - dispersant | Noveon, Lubrizol Corp, Wickliffe OH |
| 1-methoxy-2-propanol - solvent | Aldrich Chemical, Milwaukee WI |
| SR295 - pentaerythritol tetraacrylate | Sartomer Company, Exton PA |
| SR355 - Di-trimethylolpropane tetraacrylate | Sartomer Company, Exton PA |
| SR238 - Hexanedioldiacrylate | Sartomer Company, Exton PA |
| Photomer 6210 - Aliphatic Urethane diacrylate | Cognis, Monheim Germany |
| Irgacure 184 - photoinitiator | Ciba Specialties Chemical, Tarrytown NY |
| Irgacure 819 - photoinitiator | Ciba Specialties Chemical, Tarrytown NY |
| Esacure One - polymeric hydroxyl ketone | Sartomer Company, Exton PA |
| FC-4432 - polymeric fluorosurfactant | 3M Company, St. Paul MN |
| MEK—methyl ethyl ketone (solvent) | Aldrich Chemical, Milwaukee WI |
| IPA—isopropyl alcohol (solvent) | Aldrich Chemical, Milwaukee WI |
| DOWANOL ™ PM glycol ether - solvent | Dow Chemical, Midland MI |

### Example 1

### Control of Coating Solution Wetting and Particulate Distribution

A coating solution containing particulate beads was prepared and coated on a polymer substrate to demonstrate the ability of the process to coat thin films with uniform bead distribution. The coatings were applied to a 0.005 inch (0.0127 cm) thick polyethylene terephthalate (PET) substrate while varying UV LED partial polymerization.

A 40% solids by weight coating solution was prepared by combining 12.6 g SR355, 82.5 g MEK, 1.76 g MX-300 beads, 6.31 g Photomer 6210, 43.0 g SR238, 3.15 g Esacure One, and 0.33 g FC-4432 in a container and stirring to uniformly mix the solution. To this mixture, an additional 8% by weight solids of Irgacure 819 was added with mixing, to prepare the 40 wt % solids coating solution.

The general process followed the schematic presented in FIGS. 3A-C. The coating solution was supplied at a rate of 4 cc/min to a 4 inch (10.2 cm) wide slot-type coating die. The substrate was moving at a speed of 25 ft/min (762 cm/min). The 4 inch wide coating die was inside a clamshell enclosure (i.e. shroud) and the clamshell was supplied with nitrogen at a flow rate of 100 cubic feet/hour (47.2 liters/min). The clamshell was directly coupled to a small gap web enclosure provided with two quartz windows. The nitrogen flow to the clamshell provided for inerting of the small gap partial polymerization section to a level of 90 ppm oxygen.

The partial polymerization section included a Clearstone Tech UV LED unit having 18 LEDs positioned within a 1.75 inch (4.4 cm) diameter circle, available from Clearstone Technologies Inc., Minneapolis Minn. The UV LED unit was positioned directly over the quartz windows and when turned ON, was operated at either 50% or 100% power. The wavelength of the UV LED unit was 365 nm. The 365 nm UV LED produced approximately 0.11 W/cm² UV-A, and 0 W/cm² visible radiation at 100% power, and approximately 0.066 W/cm² UV-A, and 0 W/cm² visible radiation at 50% power. The LEDs were powered by a CF1000 UV-Vis LED Source, also available from Clearstone. Three samples were prepared, one with the UV LEDs turned off, one with the UV LEDs operating at 50% power, and one with the UV LEDs operating at 100% power.

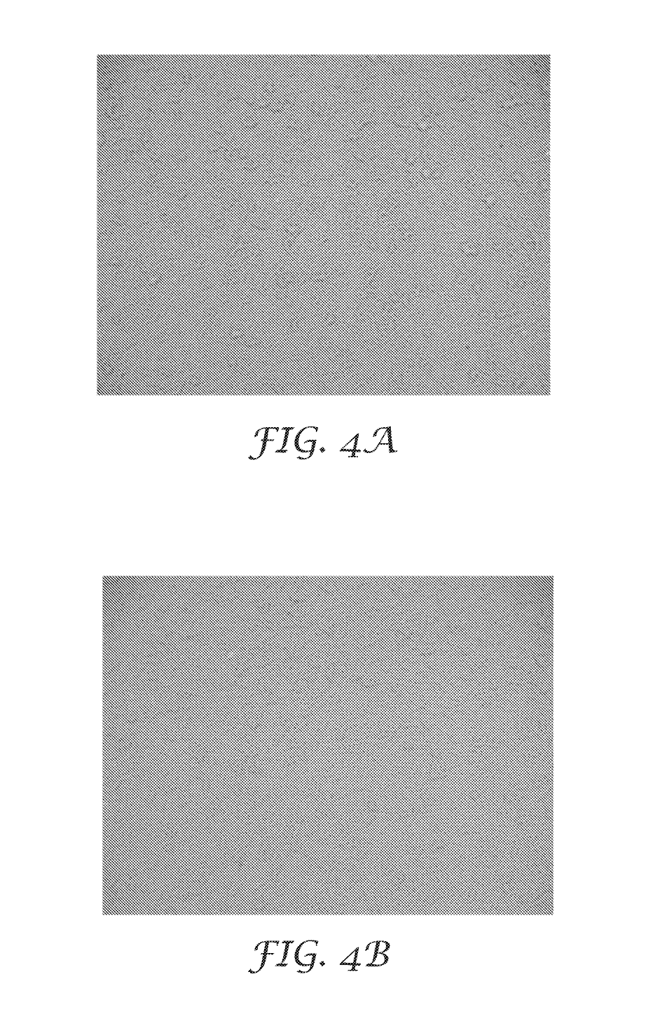

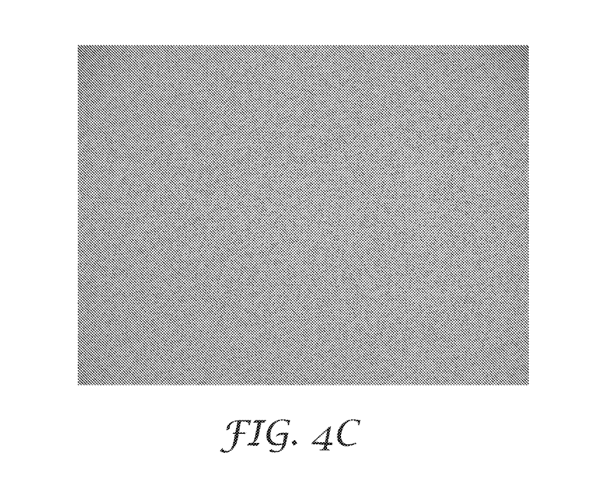

Following UV LED partial polymerization, the coated web travelled a 10 ft (3 m) span in the room environment, and then passed through two 5 ft (1.5 m) long zones of small gap drying with plate temperatures set at 170 F (77 C). The coating was then polymerized using a Fusion Systems Model 1300P (Gaithersburg Md.) fitted with an H-bulb. The UV chamber was nitrogen-inerted to approximately 50 ppm oxygen. FIG. 4A shows a photograph of the sample prepared with the UV LEDs turned off, FIG. 4B shows a photograph of the sample prepared with the UV LEDs turned to 50% power, and FIG. 4C shows a photograph of the sample prepared with the UV LEDs turned to 100% power. Comparison of FIGS. 4A, 4B, and 4C shows the ability of UV LED partial polymerization to reduce bead migration and agglomeration in a thin film coating.

### Example 2

### Defect Reduction and Increased Processing Speed

A UV curable coating solution was prepared to demonstrate the increase in processing speed that was possible by partially polymerizing the coating before removing the solvent. In this example, a “mottle” defect was generated in the coating as the web speed was increased. The partial polymerization of the coating enabled higher coating speeds before mottle was observed.

An acrylate pre-mix was prepared by combining 33.03 g SR238, 33.03 g SR295, 1.62 g Irgacure 184, 1.62 g Irgacure 819, and 126.73 g MEK in a first container and stirring the mixture. An antimony tin oxide (ATO) particulate dispersion was then prepared in a second container by mixing a solution of 60 g of ATO, 10 g Solplus® D-510, and 30 g 1-methoxy-2-propanol, to form a uniform dispersion. A high-solids coating solution was then prepared in a third container by combining 48.3 g of the acrylate pre-mix, 46.5 g of the ATO dispersion, and 5.25 g of 1-methoxy-2-propanol. The final UV curable coating solution was prepared by combining 100 g of the high-solids coating solution with an additional 17 g of MEK, an additional 0.5 g Irgacure 184 (1% by weight of solids), and an additional 1.5 g Irgacure 819 (3% by weight of solids) to result in a 42% solids by weight UV curable coating solution.

The coating solution was applied to a 0.002 inch (0.051 mm) thick polymer substrate web (CM875, a quarter wave multilayer IR reflecting film comprising 224 alternating layers of PET and coPMMA as described in U.S. Pat. No. 6,797,396), in the process shown in FIGS. 3A-3C.

The first coating solution was supplied to a 5 inch (12.7 cm) wide slot type coating die, onto a web substrate moving at a speed that was varied from 20 to 100 ft/min (6.1 to 30.5 m/min). The rate of application of the coating solution was increased as the web speed was increased to maintain a constant wet coating thickness. After coating, the web passed through a web enclosure (i.e., shroud 308 in FIG. 3A) before entering a 5 ft (152 cm) long section of Gap dryer (corresponds to the coating conditioning region 309 in FIG. 3A). The Gap dryer was operating with a 0.25 inch (0.64 cm) gap and the upper plate was set at 68 F (20 C) and lower plates set at 121 F (50 C), these conditions were set to remove a portion (i.e. a minor portion) of the solvent from the coating solution between the coating die and polymerization section. The UV LED partial polymerization apparatus was directly coupled with the downweb end of the Gap dryer.

The coated web then passed into the polymerization section. Two sets of samples were generated over the range of different web speeds. The first set of samples (A, B, C) was processed with the UV LED partial polymerization apparatus switched off. The second set of samples (D, E, F) was processed with the UV LED partial polymerization apparatus switched on to a setting of 13 amps (full power). The web speed, flow rate of coating material, Status of UV LED partial polymerization apparatus, and quantified results are presented below in Table 1.

The UV LED partial polymerization apparatus used a 395 nm UV LED water-cooled array consisting of 16 rows of LEDs with 22 LEDs in each row. The 22 LEDs in each row were equally spaced across the web width, and the 16 rows were equally spaced along the downweb direction in an area of 8″×8″ (20.3×20.3 cm). The 352 LEDs in the array were 395 nm UV LEDs (available from Cree Inc., Durham N.C.). The LED array was powered using a LAMBDA GENH750 W power supply. The power supply output was operated at 13 amps and approximately 45 volts, for the samples (D, E, F) where the UV LED apparatus was ON. The controlled environment was supplied with approximately 560 cubic feet/hour (260 liters/min) of nitrogen from two downstream gas introduction devices (e.g., manifold 332 in FIG. 3C). This resulted in approximately 35 ppm oxygen concentration in the controlled environment of the partial polymerization section.

After exiting the partial polymerization apparatus, the web travelled approximately 3 ft (0.9 m) before entering a 30 ft (9.1 m) conventional air floatation drier with all 3 zones set at 150 F (66 C). After drying and before winding, the dried coating was polymerized using a Fusion UV System, Inc. VPS/1600 (Gaithersburg, Md.). The Fusion system was configured with an H-bulb and was operated 100% power at less than 50 ppm oxygen in the cure zone.

TABLE 1

| | | Web Speed | | |
|---|---|---|---|---|
| | Coating Flow | ft/min | UV LED | Visible Mottle |
| Sample | Rate g/min | (meters/min) | On/Off | Yes/No |
| A | 17 | 25 (7.62) | Off | No |
| B | 24 | 35 (10.67) | Off | Yes |
| C | 45.5 | 65 (19.81) | Off | Yes |
| D | 42 | 60 (18.29) | On | No |
| E | 49 | 70 (21.34) | On | No |
| F | 63 | 90 (27.43) | On | Yes |

### Example 3

### Mottle Reduction in Nanoparticulate Coating

A UV curable coating solution containing nanoparticles was prepared to demonstrate the reduction in mottles that was possible by partially polymerizing the coating before removing the solvent. In this example, a mottle was generated in the coating and the partial polymerization of the coating at low power eliminated the mottle.

The coated formulation was surface treated 20 nm SiO₂ nanoparticles dispersed in SR444, prepared in the following manner. Nalco 2327 (401.5 g of dispersion, containing 164.1 g SiO₂), was charged to a one quart jar. Trimethoxy (2,4,4 trimethypentyl)silane (11.9 g), 3-(Triethoxysilyl)propionitrile (11.77 g), and 1-methoxy-2-propanol (450 g) were mixed together and charged to the silica sol with stirring. The jar was sealed and heated at 80 C for 16 hours. The modified silica sol (100 g) and SR444 (30 g) were charged to a 250 round-bottom flask. The water and solvent were removed via rotary evaporation. IPA (10 g) was then added to the flask. The composition of the resulting material was 50 g resin (40 wt % modified silica/60 wt % SR444), 6 g 1-methoxy-2-propanol, and 10 g IPA.

The above composition was further diluted to form a coating solution having 30% solids by weight, by adding a 2:1 mixture of IPA:Dowanol PM, and 0.5% (by weight of solids) Irgacure 819. The coating solution was applied to a 0.002 inch (0.051 mm) thick primed polyester (Melinex 617, DuPont Teijin Films) substrate web, in the process shown in FIGS. 3A-3C.

The first coating solution was supplied to an 8 inch (20.3 cm) wide slot type coating die, onto a web moving at a speed of 75 ft/min (22.9 m/min). The rate of application of the coating solution was adjusted to provide a wet coating thickness of about 19 microns. After coating, the web passed through a web enclosure (i.e., shroud 308 in FIG. 3A) before entering a 5 ft (152 cm) long section of Gap dryer (corresponds to the coating conditioning region 309 in FIG. 3A). The Gap dryer was operating with a 0.25 inch (0.64 cm) gap and both upper and lower plates set at 70 F (21 C), conditions set to minimize drying between the coating die and polymerization section. The UV LED polymerization apparatus was directly coupled with the downweb end of the Gap dryer.

The coated web then passed into the polymerization section which used a 395 nm UV LED water-cooled array consisting of 16 rows of LEDs with 22 LEDs in each row. The 22 LEDs in each row were equally spaced across the web width, and the 16 rows were equally spaced along the downweb direction in an area of 8″×8″ (20.3×20.3 cm). The 352 LEDs in the array were 395 nm UV LEDs (available from Cree Inc., Durham N.C.). The LED array was powered using a LAMBDA GENH750 W power supply. The power supply output can be varied from 0 to 13 amps and operated at approximately 45 volts. The controlled environment was supplied with approximately 300 cubic feet/hour (142 liters/min) of nitrogen from two downstream gas introduction devices (e.g., manifold 332 in FIG. 3C). This resulted in approximately 140 ppm oxygen concentration in the controlled environment of the polymerization section. After exiting the apparatus, the web travelled approximately 3 ft (0.9 m) before entering a 30 ft (9.1 m) conventional air floatation drier with all 3 zones set at 150 F (66 C). After drying and before winding, the polymerized and dried coating was post-polymerized using a Fusion UV Systems, Inc. VPS/1600 (Gaithersburg, Md.). The Fusion system was configured with an H-bulb and was operated 100% power at less than 50 ppm oxygen in the cure zone.

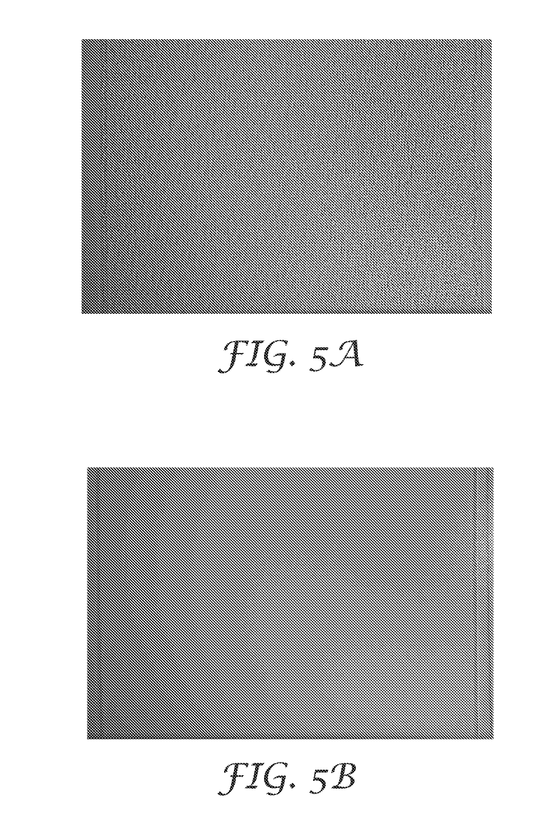

Two coatings were made, one coating with the UV LED power off, and the other coating with the UV LED power set to 0.5 amps (UV “A” dose approximately 0.005 J/cm²). A shadow photograph was taken of each of the coated films, by obliquely projecting a shadow image of the coated film onto a whiteboard with light from a fiber optic cable. The coated film was approximately 10 inches away from, and parallel to, the whiteboard. The light was projected through the coated film at an approximately 54 degree angle, to generate an approximately 14 inch wide shadow image on the whiteboard from the 8 inch wide coated film. A shadow photograph of the sample with the UV LED power OFF is shown in FIG. 5A, and a shadow photograph of the sample with the UV LED power ON is shown in FIG. 5B. Mottle coating defects are visible in FIG. 5A, but are not visible in FIG. 5B.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A process for a polymer coating, comprising:
coating a first solution comprising a polymerizable material in a solvent on a substrate;
polymerizing a first portion of the polymerizable material, forming a homogenous composition comprising a partially polymerized material in a second solution, wherein the second solution is partially depleted of the polymerizable material;
removing a major portion of the solvent from the homogeneous composition.

2. The process of claim 1, further comprising polymerizing a second portion of the polymerizable material after removing the major portion of the solvent.

3. The process of claim 1, further comprising removing a minor portion of the solvent from the solution after coating the solution on the substrate.

4-10. (canceled)

11. The process of claim 1, wherein the first solution further comprises particles, at least some of the particles becoming bound to the partially polymerized material during polymerization of the first portion of the polymerizable material.

12. The process of claim 11, wherein the particles comprise surface modified nanoparticles.

13. The process of claim 12, wherein the surface modified nanoparticles comprise reactive nanoparticles, non-reactive nanoparticles, or combinations thereof.

14. The process of claim 13, wherein a substantial portion of the reactive nanoparticles form a chemical bond with the partially polymerized material.

15. The process of claim 13, wherein a substantial portion of the non-reactive nanoparticles form a physical bond with the partially polymerized material.

16. (canceled)

17. The process of claim 1, wherein polymerizing comprises polymerizing using an actinic radiation.

18-19. (canceled)

20. The process of claim 17, wherein the actinic radiation comprises ultraviolet (UV) radiation.

21. The process of claim 20, wherein the UV radiation is produced by at least one light emitting diode (LED).

22-14. (canceled)

25. The process of claim 1, wherein the substrate is moving, and the coating, polymerizing, and removing steps are performed sequentially.

26. An apparatus, comprising:
a webline for conveying a substrate downweb from an unwind roll to a windup roll;
a coating section disposed proximate the unwind roll and capable of coating a first solution comprising a polymerizable material in a solvent onto the substrate;
a polymerization section disposed downweb from the coating section and capable of polymerizing a first portion of the polymerizable material, forming a homogenous composition comprising a partially polymerized material in a second solution, wherein the second solution is partially depleted of the polymerizable material;
a solvent removal section disposed downweb from the polymerization section, capable of removing a major portion of the solvent from the homogeneous composition.

27. The apparatus of claim 26, further comprising a coating conditioning section disposed between the coating section and the polymerization section, the coating conditioning section capable of providing a first controlled environment surrounding the substrate.

28. The apparatus of claim 26, wherein the polymerization section is capable of providing a second controlled environment surrounding the substrate.

29. The apparatus of claim 26, further comprising a second polymerization section disposed downweb from the solvent removal section, capable of polymerizing a second portion of the polymerizable material after removing the major portion of the solvent.

30. The process of claim 26, wherein polymerizing comprises polymerizing using an actinic radiation.

31. The process of claim 30, wherein the actinic radiation comprises ultraviolet (UV) radiation, visible radiation, infrared radiation, electron-beam radiation, or a combination thereof.

32. (canceled)

33. The process of claim 30, wherein the actinic radiation comprises ultraviolet (UV) radiation.

34. The process of claim 33, wherein the UV radiation is produced by at least one light emitting diode (LED).

35. (canceled)
